(19) United States
(12) Patent Application Publication
(10) Pub. No.: US 2004/0060193 A1
(43) Pub. Date: Apr. 1, 2004

(54) Drying device for printed material

(75) Inventors: Peter A. Monkewitz, Lully (CH); Trong-Vien Truong, Lausanne (CH)

Correspondence Address: OSTROLENK FABER GERB & SOFFEN, 1180 AVENUE OF THE AMERICAS, NEW YORK, NY, 100368403

(73) Assignee: Bobst SA

(21) Appl. No.: 10/674,564

(22) Filed: Sep. 30, 2003

(30) Foreign Application Priority Data
Oct. 1, 2002 (CH) 2002 1640/02

(51) Int. Cl. F26B 11/02

(52) U.S. Cl. 34/114

(57) ABSTRACT

Drying printed material, in strip or sheet, using a drying fluid propelled in the direction of the printed material through nozzles. Each nozzle has one outlet or blowing opening to blow a drying fluid or medium which has been warmed by heating elements. The nozzles are arranged in an enclosure of a drying device. Near the printed material, the drying fluid or medium presents a turbulent flux that is immediately produced at the nozzle outlets through transformation means of a laminar flux into a turbulent flux. The drying fluid or medium is extracted from the enclosure of the drying device by an exhaust pipe located between two successive nozzles, and preferably equidistant from each of the nozzles.

### BACKGROUND OF THE INVENTION

The present invention relates to a drying device for printed material, more precisely to a device using a drying fluid propelled in the direction of the printed material through nozzles.

In drying devices generally in use, printed material, in the shape of sheets or strips, goes through a drying device including two boxes in which are arranged a series of nozzles through which a drying fluid, generally hot blast, is propelled on the printed side of the printed material. After being in contact with the printed material, this hot blast is then extracted from the drying box by suction. In this kind of drying device, the hot blast is blown in the direction of the printed areas of the printed material by nozzles arranged perpendicularly to the plane defined by the material in strip or sheet. The fast speed of the printed material gives rise to a laminar flux close to its surface, which slightly isolates the printed layer from the ambient air of the drying device. This laminar flux has to then be crossed by the air coming out of the nozzles in order to insure an efficient result of the hot blast on the printed material. One solution to facilitate the transmission of the blown air from the nozzles to the printed layer lies in the destruction of the laminar flux through the creation of turbulences in its surroundings. Such a solution is described in U.S. Pat. No. 4,779,555, in which the hot blast, blown in the direction of the printed material through nozzles, is then returned by the said printed material in the direction of several deflectors placed around the nozzles in order to create turbulences in the laminar flux present around the printed surface.

The disadvantage of this device lies in the requirement for both nozzles and deflectors in order to create a turbulent flux around the printed surface of the printed material. Furthermore, this combination presents the disadvantage of not creating a continuous turbulent flux in the proximity of the printed material because at the location of the nozzle, especially at its level, the flow of the air blast that contacts the material in strips or sheets presents some laminar characteristics.

### SUMMARY OF THE INVENTION

The aim of the present invention consists in providing a simple design drying device for printed material, in strips or sheets, using simple nozzles that are not linked to complementary deflectors.

The drying device for a printed material in strips or sheets dries printed material, in strip or sheet, using a drying fluid propelled in the direction of the printed material through nozzles. Each nozzle is equipped with one outlet or blowing opening to blow a drying fluid or medium warmed by heating elements. Nozzles are arranged in an enclosed space of a drying device. The drying fluid or medium presents, near the printed material, a turbulent flux that is immediately produced at the outlets of the nozzles through transformation of a laminar flux into a turbulent flux. The drying fluid or medium is extracted from the enclosed space of the drying device by an exhaust pipe located between two successive nozzles, preferably equidistant from each of the nozzles.

The invention will be more understandable along the following description that will be achieved in relation with the enclosed drawings that illustrate, schematically and as an example, one type of execution of this drying device.

### BRIEF DESCRIPTION OF THE DRAWINGS

FIG. 1 is a schematic cross-sectional view of a drying device according to the present state of the technology.

FIG. 2 is a schematic partial cross-sectional view of another drying device according to the current state.

FIG. 3 is a schematic partial cross-sectional view according to the axis III-III of FIG. 2.

FIG. 4 is a cross-sectional view showing the location of the nozzles in the drying device.

FIG. 5 is a cross-sectional view of one of the nozzles of the drying device.

FIG. 6 represents a perspective view of one execution of one of the nozzles of the drying device.

### DESCRIPTION OF PRIOR ART EMBODIMENTS

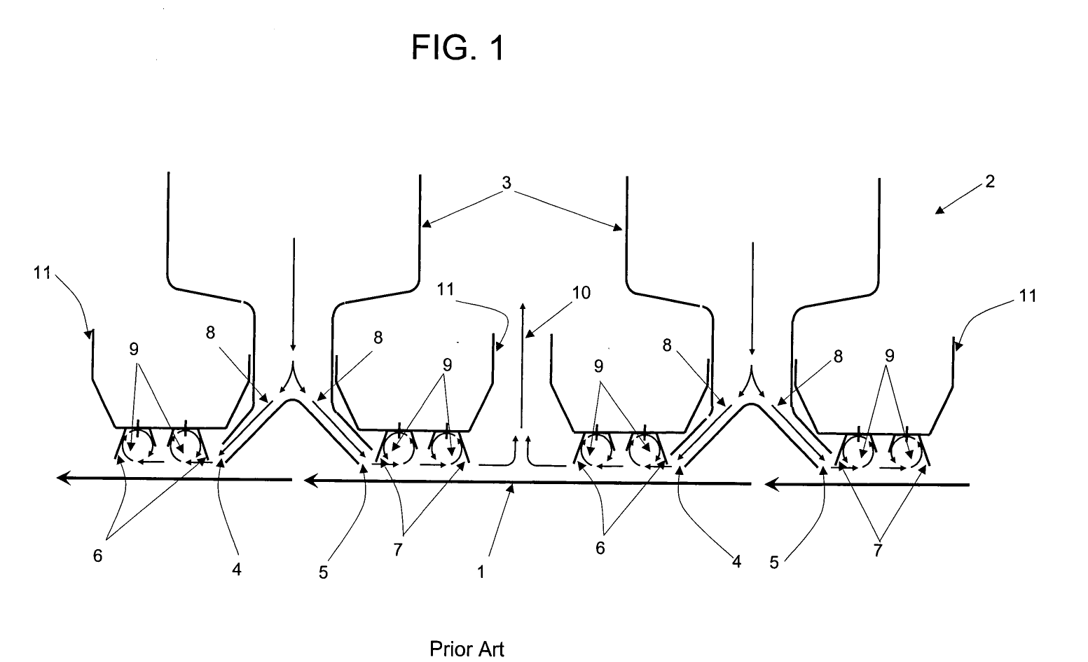

FIG. 1 is a schematic cross-sectional view of the housing 2 of a drying device, according to the known state of the art, in which the printed material is running on a path opposed to outlets from the nozzles 3 in a direction across the outlets from the nozzles. Each nozzle 3 comprises two blowing ports 4, 5. Each blowing port 4, 5 is associated with a series of deflectors 6, 7. The drying fluid has laminar flux 8, i.e. its flow is laminar, blowing out of the blowing ports 4, 5. The fluid is propelled in the direction of the printed material through a nozzle 3 and is then returned by the surface of the printed material 1 in the direction of several deflectors 6, 7 located around nozzles 3 in order to create an effect of turbulence in the existing laminar flux around the printed surface. This drying fluid with turbulent flux 9 reaches the printed material 1 and destroys the laminar characteristics of the existing flux in proximity to the surface of the printed material 1, so that the drying fluid can mix with the solvent resulting from the deposit of ink on the printed material. This favors the suppression of solvents present over the printed material. This mixture 10 of drying fluid and solvents is then aspirated by an exhaust pipe 11.

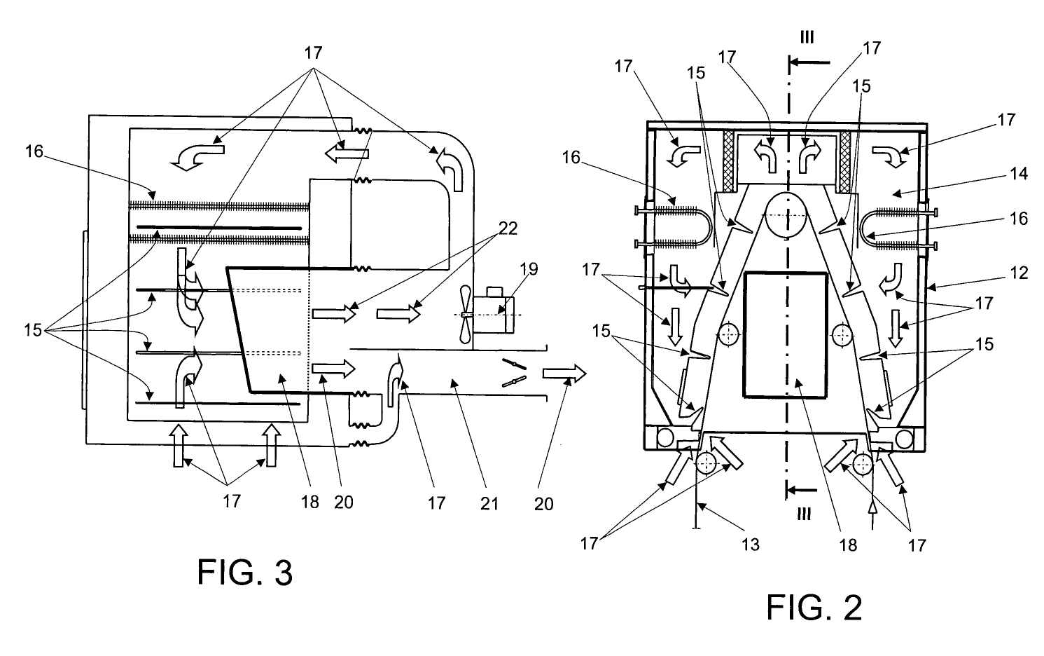

FIG. 2 is a schematic cross-sectional view of another conventional drying device, in which a printed material 13 is running. This drying device comprises an enclosed space 14. Nozzles 15 in the space 14 are intended to blow a drying fluid warmed by heating elements 16. The drying fluid circulation is illustrated by arrows 17. Once loaded with solvents, the drying fluid is aspirated by an exhaust pipe 18 with the help of first aspiration mean 19 that could be, for example, a fan. A part 20 of the mixture formed by the drying fluid and the solvents is drained out through a pipe 21 linked to a second aspiration means (not illustrated). The rest of the mixture 22 is recycled within the enclosed space 14 (i.e. FIG. 3).

FIG. 3 is a schematic partial cross-sectional view along the line III-III of FIG. 2, in which the same reference digits are used to indicate the various elements of the drying device. In this illustration of the drying device, the draining of the drying fluid loaded with solvents is realized at the center of the device and that this flow of drying device has a direct impact on the printed surface of the printed material through the medium of its other side that could be possibly unprinted.

The embodiment of FIGS. 2 and 3 has features which may be used in the preferred embodiments described below, except for the conversion of laminar flow to turbulent flow.

### DESCRIPTION OF PREFERRED EMBODIMENTS

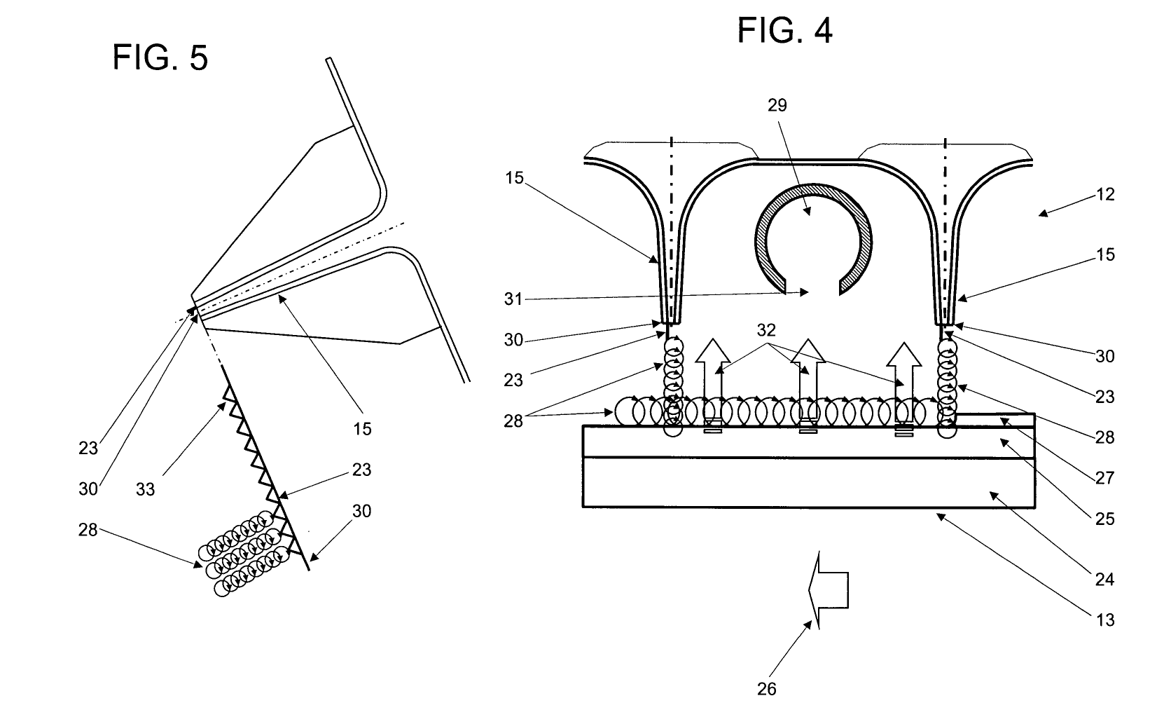

FIG. 4 is a cross-sectional view illustrating a possible disposition of nozzles 15 of the drying device 12. Features of the drying device not directly concerned with the conversion of drying fluid flow from laminar to turbulent are incorporated from FIGS. 1, 2 and 3 hereof into the preferred embodiments hereof. Only two nozzles are represented in this Figure. Each nozzle 15 is kitted out with means 23 for transforming the flux of the drying fluid that is in laminar flow in nozzle 15 and then becomes turbulent directly after leaving nozzle 15. This turbulent flux is represented by the reference number 28. The printed material 13 here comprises a support 24, generally comprised of cardboard or any other material that can possibly receive a layer of ink 25 loaded with solvents. The printed material 13 runs at fast speed in the direction indicated by arrow 26, producing a laminar air layer 27 at the surface of the material 13 that has to be broken in order to facilitate removal of the solvents and thus ensure the efficiency of the drying process. The mixture of drying fluid and solvents, indicated by 32, is then aspirated by an exhaust pipe 29 located between two successive nozzles 15. This exhaust pipe 29 can comprise a simple tube. The location of the exhaust pipe 29 is preferably equidistant from each of the two successive nozzles 15, although this exhaust pipe 29 may be at any distance from each of the successive nozzles 15. Openings 30 of nozzles 15 are each presented in the form of a slot that stretches all along nozzles 15, that is across the printed material 13. The exhaust pipe 29 comprises an opening 31 that also stretches along the entire exhaust pipe 29 and corresponding to the length of nozzles 15.

FIG. 5 is a cross-sectional view of a nozzle 15 of the drying device 12. The opening 30 of nozzle 15 is equipped with mechanical mean 23 of transformation of the flow of the drying medium flux. This mechanical mean 23 for transforming the flow of the drying medium flux is presented here in the form of a notched or crenelated structure 33 directly tooled at one side of the extremity of opening 30 of nozzle 15. This tool may have this crenelated structure 33 at each side of the extremity of opening 30 of nozzle 15. Preferably, the notched structure 33 is placed parallel to the downstream side, relative to the moving direction 26 of the printed material, of the extremity of opening 30, in other words parallel to the direction of the drying fluid in nozzle 15, as shown in FIG. 4. However, an inclined notched structure with an angle from 0 up to 90° relative to the side of the extremity of the opening 30 can be considered. An alternative perpendicular arrangement of the notched structure 33 relative to the side of the extremity of opening 30, in other words, perpendicular to the direction of the drying fluid in nozzle 15, can also be considered, as shown in FIG. 5. Also, a piece with a notched structure can be placed on one side of opening 30 in the case, for example, of a “retrofit” on one existing nozzle with slot.

It has been shown through workshop test that a tooth-shaped notched profile generates a high intensity turbulent flow enabling excellent destruction of the laminar flux located near the printed material. This destruction allows a significant improvement in the drying time of the printed material when the material moves at a speed of from 100 up to 1000 m/min. In the example just described, nozzles 15 are arranged perpendicular to the surface of the printed material 13 and their outlets are close to this surface. An inclined disposition of nozzle 15 relative to the surface of the printed material 13 can also be considered. Of course, the invention is not limited to this example. In the border-line case and if necessary, each extremity of openings 30 of nozzles 15 could be equipped with two notched structures 33.

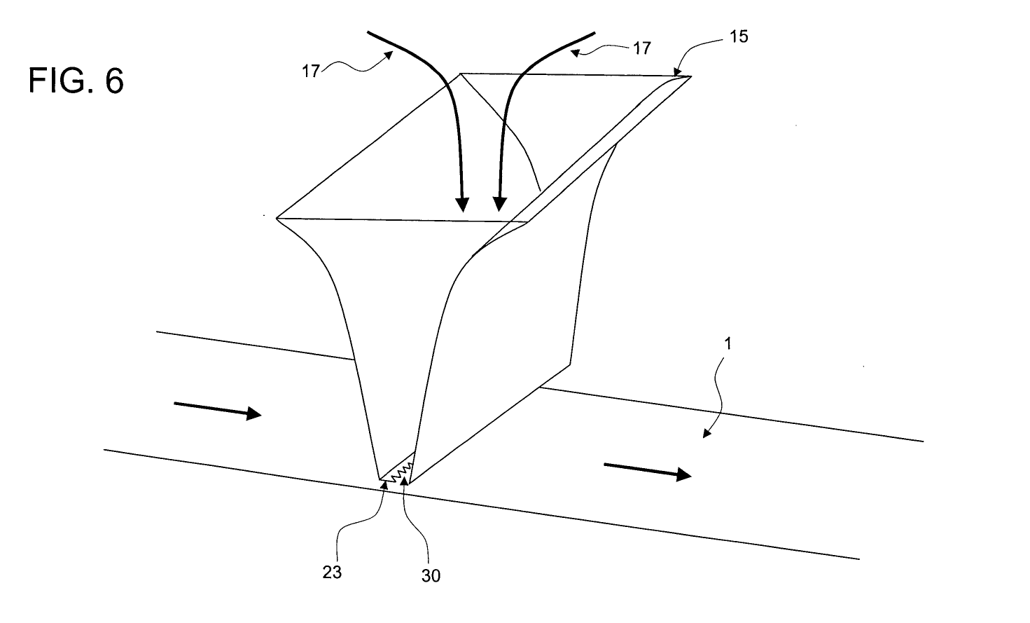

FIG. 6 is a perspective view of one execution of one of the nozzles 15 of the drying device 12. The opening 30 of nozzle 15 is equipped with mechanical mean 23 of transformation of the flow of the drying medium flux. This mechanical mean 23 is presented here perpendicular to the drying fluid direction through the opening 30 of nozzle 15. The mechanical mean 23 of transformation could also be located parallel to the drying fluid direction through the opening 30 of nozzle 15, as shown in FIG. 4.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A drying device for drying printed material moving past the drying device, the drying device comprising:
at least one nozzle for transmitting a drying fluid, the nozzle having an outlet directed so that the drying fluid is propelled toward the printed material moving past the nozzle outlet, wherein the nozzle is shaped and positioned so that the drying fluid would normally develop a laminar flow through the outlet of the nozzle;
a device at the outlet of the nozzle, shaped and positioned for creating a turbulent flux of the drying fluid and breaking up the laminar flow as it exits the nozzle outlet; and
an exhaust conduit positioned and operable for receiving drying fluid after it has blown on the printed material.

2. The drying device of claim 1, comprising a plurality of the nozzles arrayed along a path of the printed material moving past each of the nozzle outlets.

3. The drying device of claim 2, further comprising an enclosure in which the nozzle outlets are disposed;
guiding devices for guiding the printed material through the enclosed space and past the nozzle outlets; and
the exhaust device also having an inlet in the enclosure for exhausting the drying fluid from the enclosure after the fluid has acted on the printed material.

4. The drying device of claim 3, further comprising a heating element positioned for heating the drying fluid before it contacts the printed material.

5. The drying device of claim 1, wherein the nozzles are oriented so that the outlets thereof are oriented perpendicular to and close to the surface of the printed material moving past.

6. The drying device of claim 1, wherein the nozzles are oriented so that the outlets thereof are oriented inclined relative to and close to the surface of the printed material moving past.

7. The drying device of claim 3, wherein the exhaust device inlet is located between two successive nozzles along the path of the printed material past the nozzle outlets.

8. The drying device of claim 7, wherein the exhaust device inlet is located equidistant between two successive nozzles.

9. The drying device of claim 1, wherein the device at the outlet of the nozzle is a mechanical device.

10. The drying device of claim 1, wherein the nozzle has sides defining the nozzle outlet and the device for creating the turbulent flux is installed in the nozzle at an extremity of at least one of the sides of the nozzle outlet.

11. The drying device of claim 10, wherein the device for creating turbulent flux comprises a notched or crenelated structure.

12. The drying device of claim 11, wherein the notched or crenelated structure has a direction in which it extends which is parallel to the side of the nozzle outlet at which the structure is located and extends along that side of the nozzle outlet.

13. The drying device of claim 12, wherein the notched or crenelated structure is at the nozzle outlet.

14. The drying device of claim 13, wherein the notched or crenelated structure is disposed at a downstream side of the nozzle outlet which is downstream with respect to the path of the printed material past the nozzle outlet and relative to the moving direction of the printed material past the nozzle outlet.

15. The drying device of claim 11, wherein the device for transforming the laminar flux into a turbulent flux comprises a piece located on at least one side of the nozzle outlet and the piece having the notched or crenelated structure thereon.

16. The drying device of claim 15, wherein the piece is so shaped and positioned that the notched or crenelated structure has an angle of between 0° to 90° relative to the side of the nozzle outlet.
